(19) United States
(12) Patent Application Publication
(10) Pub. No.: US 2014/0345276 A1
(43) Pub. Date: Nov. 27, 2014

(54) ORGANIC RANKINE CYCLE FOR CONCENTRATED SOLAR POWER SYSTEM WITH SATURATED LIQUID STORAGE AND METHOD

(71) Applicants: Bhaskara Kosamana, Bangalore (IN); T. Saravanaram, Bangalore (IN); Senthilkumar Muniaraj, Bangalore (IN)

(72) Inventors: Bhaskara Kosamana, Bangalore (IN); T. Saravanaram, Bangalore (IN); Senthilkumar Muniaraj, Bangalore (IN)

(73) Assignee: NUOVO PIGNONE S.p.A., Florence (IT)

(21) Appl. No.: 14/009,190

(22) PCT Filed: Mar. 30, 2012
(86) PCT No.: PCT/EP2012/055760

§ 371 Date: Aug. 13, 2014

(30) Foreign Application Priority Data
Apr. 1, 2011 (IN) 941/DEL/2011

(51) Int. Cl. F03G 6/06

(52) U.S. Cl. CPC F03G 6/065
USPC 60/641.8; 60/641.1

(57) ABSTRACT

A closed loop system for producing energy using an Organic Rankine Cycle (ORC) and an ORC fluid, comprising a first solar power source (52) configured to heat an ORC liquid to a saturated ORC liquid, a second solar power source (70) fluidly connected to the first solar power source and configured to vaporize the saturated ORC liquid to become ORC vapor, and a turbo-machine (54) configured to receive ORC vapor and produce mechanical energy by expanding the ORC vapor.

### CROSS-REFERENCE TO RELATED APPLICATIONS

This is a national stage application under 35 U.S.C. §371(c) of prior-filed, co-pending, PCT application serial number PCT/EP2012/055760, filed on Mar. 30, 2012, which claims priority to Indian patent application serial number 941/DEL/2011, filed on Apr. 1, 2011, the entire contents of which are incorporated by reference herein.

### BACKGROUND OF THE INVENTION

1. Field of the Invention

Embodiments of the present invention generally relate to power generation systems and, more particularly, to Organic Rankine Cycle (ORC) systems having a solar power source and a saturated liquid storage.

2. Description of the Prior Art

Rankine cycles use a working organic fluid in a closed cycle to gather heat from a heating source or a hot reservoir and to generate power by expanding a hot gaseous stream through a turbine or an expander. The expanded stream is condensed in a condenser by transferring heat to a cold reservoir and pumped up to a heating pressure again to complete the cycle. Solar power sources are known to be used as the heating source or the hot reservoir. For example, Concentrating Solar Power (CSP) systems use lenses or mirrors and tracking systems to focus a large area of sunlight into a small beam. The concentrated heat is then used as the heat source for a conventional power plant. A wide range of concentrating technologies exists. The most developed are the parabolic trough, the concentrating linear fresnel reflector, the Stirling dish and the solar power tower. Various techniques are used to track the Sun and focus light. In all of these systems a working fluid is heated by the concentrated sunlight, and is then used for power generation or energy storage.

A generic ORC system is discussed with regard to FIG. 1. FIG. 1 shows a power generation system 10 that includes a heat exchanger 2, also known as a boiler, a turbine 4, a condenser 6 and a pump 8. Walking through this closed loop system, beginning with the heat exchanger 2, an external heat source 3, e.g., hot flue gases, heats the heat exchanger 2. This causes the received pressurized liquid medium 12 to turn into a pressurized vapor 14, which flows to the turbine 4. The turbine 4 receives the pressurized vapor stream 14 and can generate power 16 as the pressurized vapor expands. The expanded lower pressure vapor stream 18 released by the turbine 4 enters the condenser 6, which condenses the expanded lower pressure vapor stream 18 into a lower pressure liquid stream 20. The lower pressure liquid stream 20 then enters the pump 8, which both generates the higher pressure liquid stream 12 and keeps the closed loop system flowing. The higher pressure liquid stream 12 then is pumped to the heat exchanger 2 to continue this process.

One working fluid that can be used in a Rankine cycle is an organic working fluid. Such an organic working fluid is referred to as an ORC fluid. ORC systems have been deployed as retrofits for engines as well as for small-scale and medium-scale gas turbines, to capture waste heat from the hot flue gas stream. This waste heat may be used in a secondary power generation system to generate up to an additional 20% power on top of the power delivered by the engine producing the hot flue gases alone.

With the development of solar power sources, the ORC cycle has been applied to such a system as described. For example, in FIG. 2, there is a system 30 having a solar collector 32, a steam-engine with heat exchanging condenser 34, a storage tank 36 for a working fluid, and a pump 38 for delivering the working fluid to the solar collector 32. The solar collector 32 is equipped with a leveling valve 40 on its inlet for an ORC working fluid pumped by pump 38 from the storage tank 36 to an upper tank 42. The vaporized ORC working fluid is provided from the solar collector 32 to a steam turbine 44 which may be connected to a power generator 46.

However, the existing solar power systems are not efficient. In addition, the existent solar power systems have difficulties in producing energy when the sun is not available. Accordingly, systems and methods for improving the efficiency of ORC systems in power generation systems are desirable.

### BRIEF SUMMARY OF THE INVENTION

According to an embodiment of the present invention, there is provided a closed loop system for producing energy using an Organic Rankine Cycle (ORC) and an ORC fluid. The system comprises a first solar power source configured to heat an ORC liquid to a saturated ORC liquid, a second solar power source fluidly connected to the first solar power source and configured to vaporize the saturated ORC liquid to become ORC vapor, and a turbo-machine configured to receive ORC vapor and produce mechanical energy by expanding the ORC vapor.

According to an embodiment of the present invention, there is provided a closed loop system for producing energy using an Organic Rankine Cycle (ORC) and an ORC fluid. The system comprises a turbo-machine configured to transform heat into mechanical energy, a recuperator fluidly connected to an output of the turbo-machine and configured to remove heat from the vaporized ORC fluid, a cooling device fluidly connected to the recuperator and configured to transform the vaporized ORC fluid back to the ORC liquid, a pump fluidly connected between the cooling device and the recuperator and configured to pump the ORC liquid to the recuperator, a first solar power source configured to transform by heating the ORC liquid to a saturated ORC liquid, and a second solar power source fluidly connected to the first solar power source and configured to vaporize the saturated ORC liquid to become ORC vapor, wherein the turbo-machine is configured to receive the ORC vapor from the second solar power source.

According to another embodiment of the present invention, there is provided a method for generating energy using an Organic Rankine Cycle (ORC). The method comprises transforming ORC liquid through heating within a first solar power source into a saturated ORC liquid in a closed loop system, storing the saturated ORC liquid in a storage tank, controlling a flow of the saturated ORC liquid to a second solar power source or another device for transforming the saturated ORC liquid to ORC vapor, expanding the ORC vapor in a turbo-machine to produce the energy, and cooling the ORC vapor to change it back to the ORC liquid and returning the ORC liquid back to the first solar power source.

### BRIEF DESCRIPTION OF THE DRAWINGS

Embodiments of the present invention will be more apparent to those skilled in the art upon reading the following description with reference to the accompanying drawings, in which:

FIG. 1 is a schematic diagram of an ORC cycle;

FIG. 2 is a schematic diagram of an ORC cycle configuration used with a solar power source;

FIG. 3 is a schematic diagram of an ORC cycle configuration used with a solar power source according to an exemplary embodiment of the present invention;

FIG. 4 is a schematic diagram of an ORC cycle configuration used with a solar power source and a secondary heat source according to an exemplary embodiment of the present invention;

FIG. 5 is a schematic diagram of an ORC cycle configuration used with a solar power source in a two closed loops system according to an exemplary embodiment of the present invention;

FIG. 6 is a schematic diagram of an ORC cycle configuration used with a solar power source and a secondary heat source in a two closed loops system according to an exemplary embodiment of the present invention;

FIG. 7 is a flowchart of a method for using an ORC cycle configuration with a solar power source according to an exemplary embodiment of the present invention;

FIG. 8 is a flow chart of an ORC cycle configuration used with a solar power source in a two closed loops system according to an exemplary embodiment of the present invention;

FIG. 9 is a closed loop system for generating power that includes first and second solar power sources according to an exemplary embodiment of the present invention;

FIG. 10 is a P-H chart of an ORC fluid that undertakes various thermal transformations through a closed loop system according to an exemplary embodiment of the present invention; and

FIG. 11 is a flowchart of a method for producing power by using a closed loop system with two solar power sources according to an exemplary embodiment of the present invention.

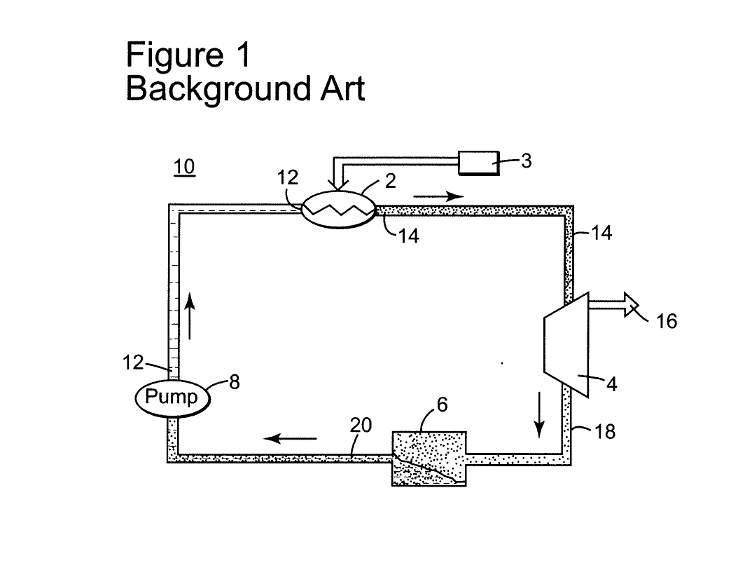

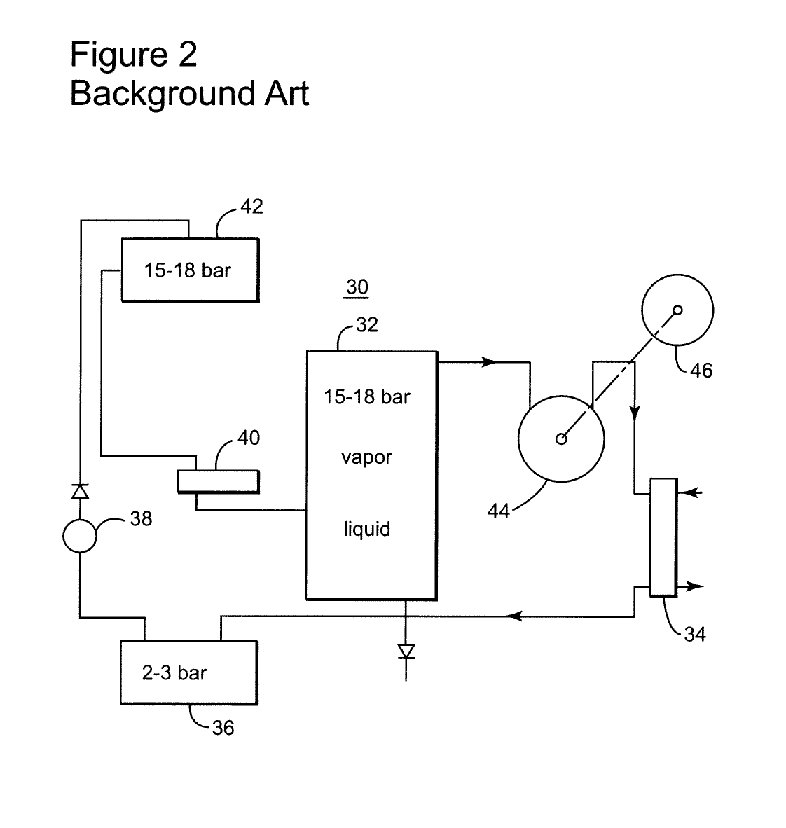

### DETAILED DESCRIPTION OF THE INVENTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims. For simplicity, the following description refers to an ORC cycle used with a solar power source for producing energy with an expander. However, the solar power source may be different, or the expander may be replaced with another turbo-machine for producing energy.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

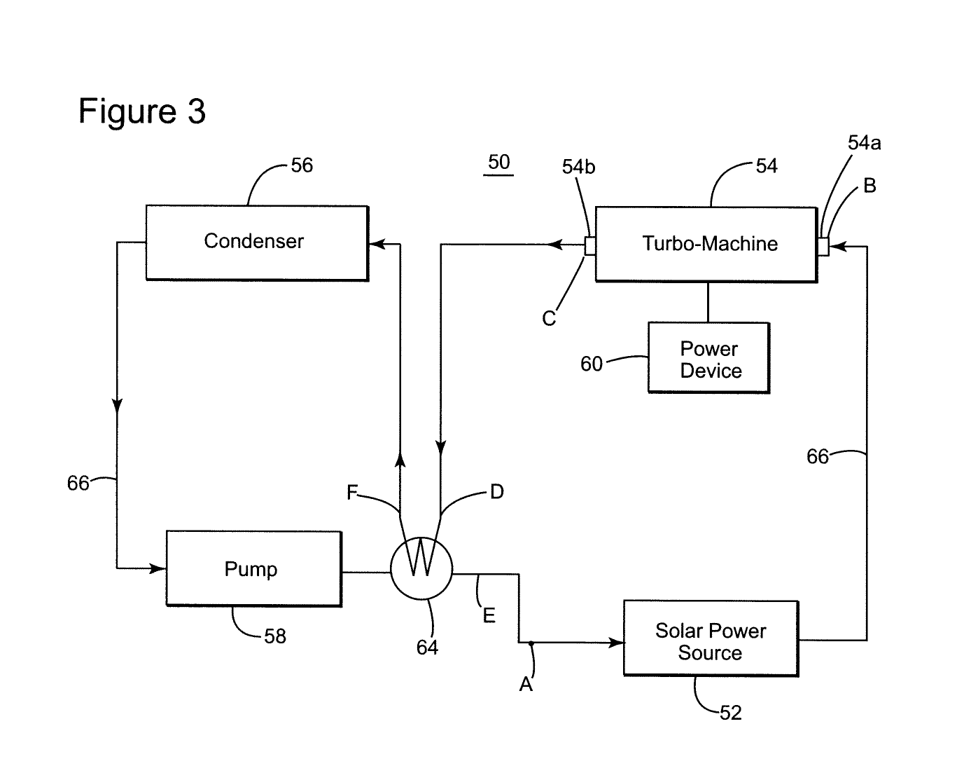

According to an exemplary embodiment illustrated in FIG. 3, a system 50 for power generation using an Organic Rankine Cycle (ORC) includes a solar power source 52 that is configured to vaporize a medium flowing through the system and a turbo-machine 54 configured to generate energy/power by expanding the vaporized medium. A condenser 56 ensures that the vaporized medium is returned to its liquid phase and a pump 58 increases the pressure of the liquid medium and maintains the medium flowing through the system.

The medium may be an organic fluid traditionally used in ORC systems. However, for an improved efficiency, a cyclopentane based fluid may be used as the medium according to an application. Cyclopentane is a highly flammable alicyclic hydrocarbon with chemical formula C5H10. It consists of a ring of five carbon atoms each bonded with two hydrogen atoms above and below the plane. It occurs as a colorless liquid with a petrol-like odor. Its melting point is −94° C. and its boiling point is 49° C. Other mediums may also be used. According to an exemplary embodiment, the ORC medium includes cyclopentane mixed with one or more of 2-Methyl Pentane, npentane and isopentane. For example, one possible combination is cyclopentane around 95%, 2-Methyl Pentane around 3.5%, npentane 0.75% and isopentane around 0.75%.

The solar power source 52 may be any of the known solar sources. However, the embodiments to be discussed next are optimized for concentrated solar power (CSP) systems. A CSP system is different from a photovoltaic system as the photovoltaic system directly transforms the solar energy into electricity. A CSP system needs a medium to be vaporized based on the solar energy and then that energy is extracted with an appropriate turbo-machine, e.g., an expander or a turbine. Thus, the medium used in the embodiment shown in FIG. 3 experiences various thermodynamic processes as it passes the various elements of the system.

The turbo-machine 54 may be any machine that is configured to extract energy from the vaporized medium and transform this energy into, e.g., mechanical energy. In this regard, an expander is configured to receive a vaporized medium which determines airfoils or an impeller of the expander to rotate around a transversal axis. Thermodynamic energy of the gas (vaporized medium) is extracted during the expansion process which makes a shaft (that holds the airfoils or impeller) of the expander to rotate, thus generating the mechanical energy. This mechanical energy may be used to activate a power device 60, for example, a compressor or an electrical power generator for producing electricity. In other words, the system discussed in the exemplary embodiment may be used to generate power or to drive a machine, e.g., turbo-machine.

The expander may be a single stage or plural stages expander. A single stage expander has only one impeller and the vaporized gas is provided to the exhaust of the expander after passing the single impeller. A multi-stage impeller has plural impellers and the expanded medium from one impeller is provided to a next impeller for further extracting energy from the medium. The expander may be a centrifugal or an axial machine. A centrifugal expander receives the vaporized medium along a first direction (e.g., Y axis) and discharges the expanded medium at a second direction (e.g., X direction) substantially perpendicular to the first direction. In other words, a centrifugal force is used to rotate the shaft of the expander. In an axial expander the medium enters and exits the expander along the same direction, similar to the jet engine of an airplane.

The condenser 56 may be air cooled or water cooled and its purpose is to further cool the expanded medium from the turbo-machine 54 so that the medium becomes liquid. The pump 58 may be any pump known in the art and suitable for increasing the pressure of the medium to a desired value. Heat from the medium exhausted from the expander 54 may be removed in a recuperator 64 and provided to the liquid medium being provided to the solar power source 52. The recuperator 64 may be as simple as a container having two pipes that share a same ambient. For example, the liquid medium (from the pump) flows through a first pipe while the vaporized medium (from the expander) flows through a second pipe. Because the same ambient is present around the first and second pipes, heat from the second pipe migrates to the first pipe, thus heating the liquid medium. Other more sophisticated recuperators may be used.

The flow of the medium through the system 50 is now discussed in more details. Assume that the medium flow is followed from point A. At this point the liquid medium is at a high pressure (e.g., 40 bar) due to the pump 58 and at a low temperature (e.g., 55° C.). After the liquid medium passes through the solar power source 52, its temperature is increased (e.g., at 250° C.). The numbers used in this and other exemplary embodiments are for illustration purposes and not intended to limit the embodiments. Those skilled in the art would recognize that these numbers change from system to system as the characteristics of the system changes.

While passing the solar power source 52, the medium may undergo a phase transformation, i.e., from liquid medium to vaporized medium. During the passing through the solar power source 52, the solar energy is transferred from the sun light to the medium. The vaporized medium arrives at point B and enters an inlet 54a of the expander 54 and makes the shaft of the expander to rotate, transforming the solar energy into mechanical energy. The expanded medium, which may be still a gas and not a liquid (e.g., temperature at point C is about 140° C. and pressure is about 1.3 bar) is then released from the expander at outlet 54b.

As there is still energy (heat) left in the vaporized medium at point C, this medium is directed to the recuperator 64 to further remove heat from it. The heat removed in the recuperator 64 from the vaporized medium at point D is provided to the liquid medium at point E (inside the recuperator) prior to providing the liquid medium to the solar power source. The cooled vaporized medium at point F, is now cooled down in the condenser 56 to bring it back to a liquid phase. Then, the liquid medium is provided to the pump 58 and the cycle repeats. It is noted that the piping 66 that takes the medium from a component to the other is sealed so that the medium does not escape outside the system 50. In other words, the system shown in FIG. 3 is a closed loop system.

The above discussed system increases the conversion efficiency of the solar energy to electrical energy when an electric power generator 60 is used. Also, the present system does not need water for its medium and the medium may be directly vaporized by the solar power source. If using the cyclopentane based fluid, it is noted that this medium is directly vaporized in the solar power source as the boiling temperature of cyclopentane is around 49° C.

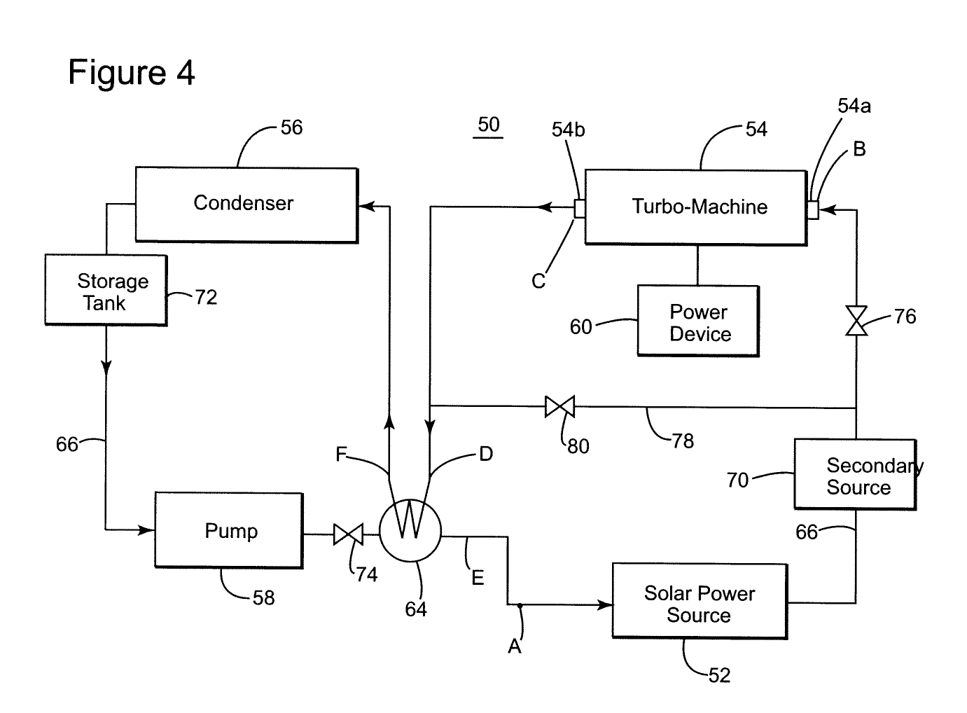

Some modifications of the system 50 shown in FIG. 3 are possible and these are discussed now with regard to FIG. 4. According to an exemplary embodiment, a secondary heat source 70 may be added, for example, downstream the solar power source 52 and upstream the expander 54. In another application, the secondary power source 70 may be provided at location A. The secondary power source may be solar, geothermal, fossil, nuclear or other known power sources. For example, the exhaust of a turbo-machine or a power plant may be the secondary power source.

In another application, a storage tank 72 may be provided for storing the cyclopentane based medium. In one exemplary embodiment, the storage tank is provided downstream the condenser 56. Various valves 74 and 76 may be provided along the piping system for controlling the amount of the medium flowing in the system. In still another exemplary embodiment, a balancing line 78 and a valve 80 may be provided for controlling the flow of the medium through the system.

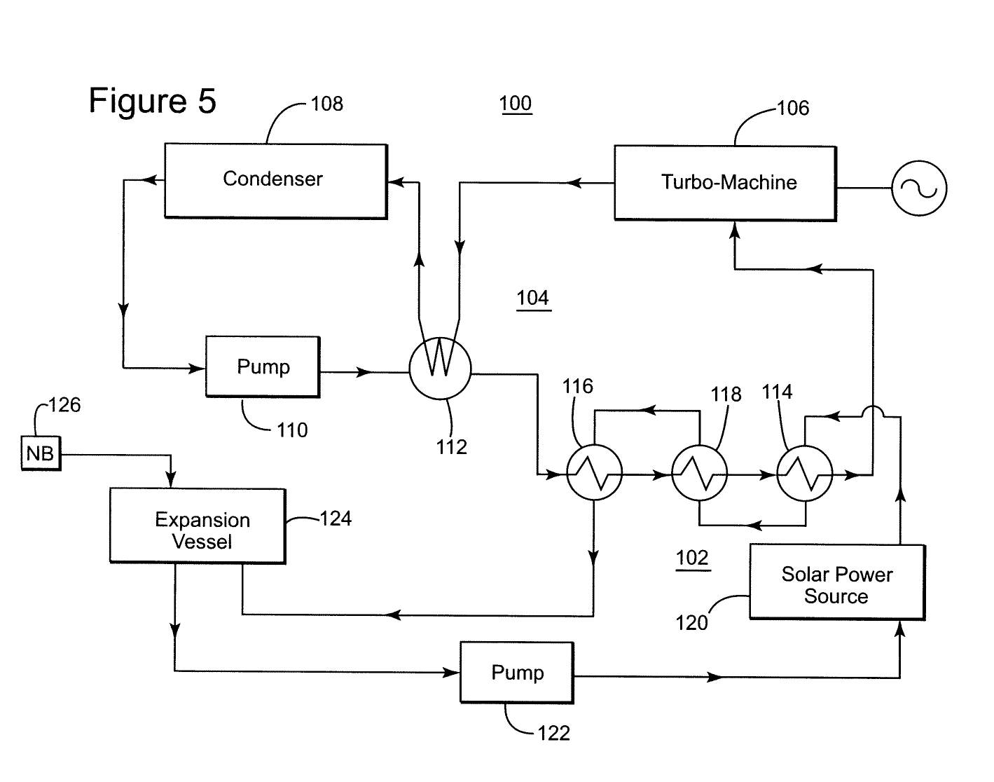

A different system is presented in FIG. 5. According to an exemplary embodiment, the system 100 may include a first closed loop system 102 and a second closed loop system 104. The second closed loop system 104 may include a turbo-machine 106, a condenser 108, a pump 110 and a recuperator 112 similar to those shown in FIGS. 3 and 4 and also similarly connected to the system of the embodiments shown in FIGS. 3 and 4. However, instead of the solar power source shown in FIG. 3, the second closed loop system may include one or more vaporizers 114 and one or more heat exchanging devices 116. FIG. 5 shows two heat exchanging devices 116 and 118 but one device is enough for the system to function. In one application, no heat exchanging device is necessary.

The first closed loop system 102 may include a solar power source 120, similar to the solar power source 52 of FIG. 3 and a pump 122 similar to the pump 58 of FIG. 3. The first closed loop system 102 may use an oil based substance as the flowing medium while the second closed loop system 104 may be an ORC system that uses a cyclopentane based fluid as the flowing medium. The organic medium of the second closed loop system 104 is not circulating through the solar power source 120 in this exemplary embodiment but rather is placed in thermal contact with the oil based substance of the first closed loop system 102 for transferring heat from the solar power source.

In this regard, the oil based substance from the solar power source 120 vaporizes in the vaporizer 114 the medium of the second closed loop system and provides the vaporized medium to the turbo-machine 106. In addition, it is possible to further use the oil based substance to pre-heat the medium of the second closed loop cycle in one or more heat exchanging devices 116 and 118. However, according to an exemplary embodiment, the heat exchanging devices 116 and 118 may be omitted. The cooled oil based substance arrives then at an expansion vessel 124 from which it flows to the pump 122 for being again provided to the solar power source 120. The oil based substance does not mixes up with the medium of the second closed loop system or with the ambient. The expansion vessel 124 may be in fluid communication with a nitrogen source 126 that is configured to nitrogen blanket a top portion (inside) of the expansion vessel 124. Although the nitrogen enters inside the expansion vessel, the nitrogen does not flow through the first closed loop system 102 as it flows above the oil based substance.

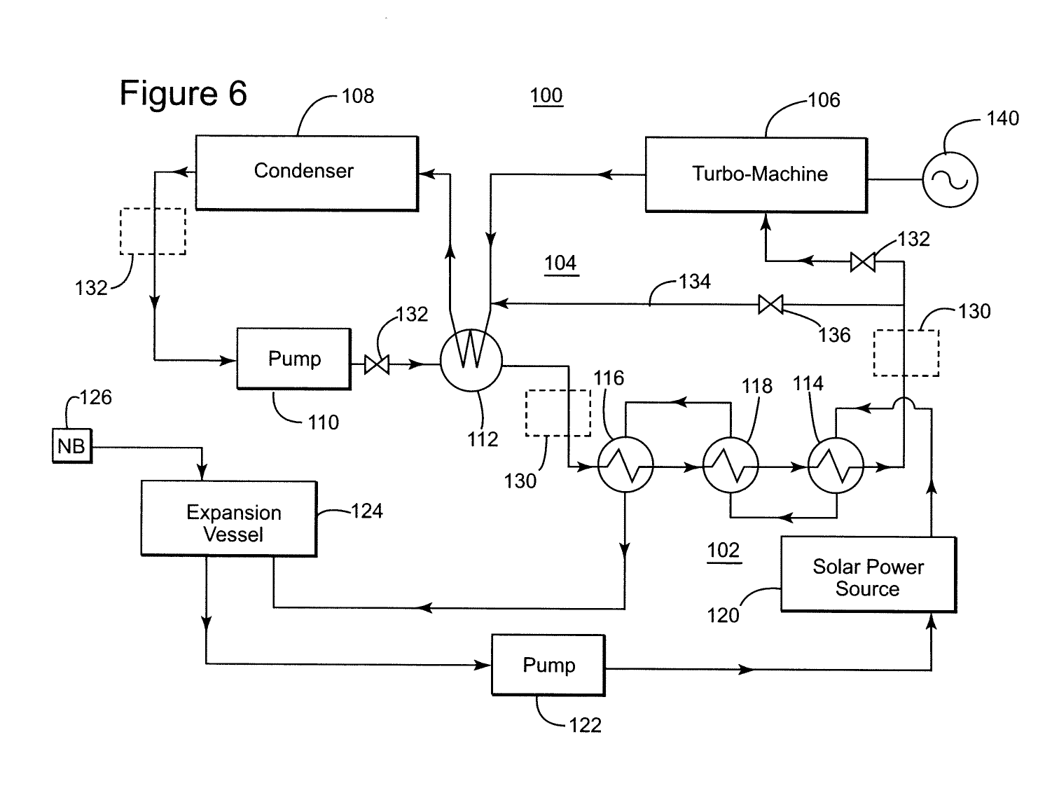

According to an exemplary embodiment illustrated in FIG. 6, various elements, as shown in FIG. 4, may be added to the system 100. For example, secondary heat sources 130 may be added in the second closed loop system, upstream or downstream from the vaporizer 114 for further heating the medium of the second closed loop system. Valves 132 may be added to controlling the flow of the medium and a balancing line 134 with corresponding valve 136 may be provided in the second closed loop system. A generator 140 or other turbo-machine may be connected to the expander 106 in the second closed loop system 104.

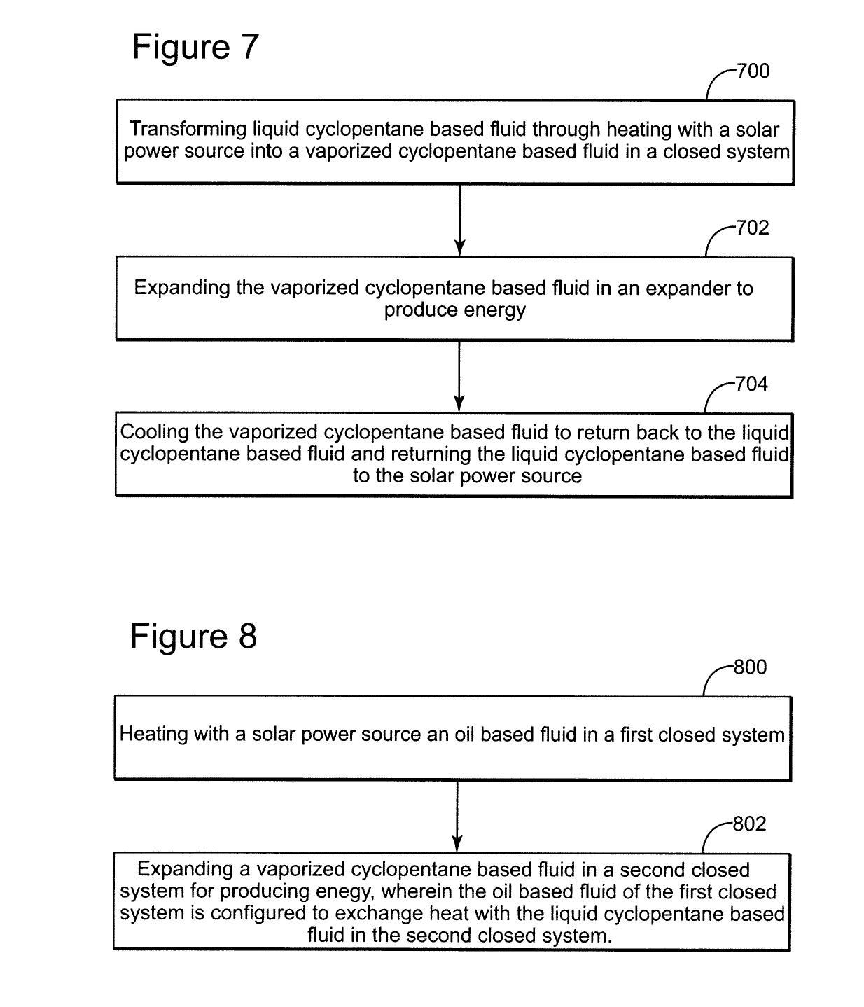

Methods for operating such systems are now discussed. According to an exemplary embodiment illustrated in FIG. 7, there is a method for power generation using an Organic Rankine Cycle (ORC). The method includes a step 700 of transforming liquid cyclopentane based fluid through heating with a solar power source into a vaporized cyclopentane based fluid in a closed system; a step 702 of expanding the vaporized cyclopentane based fluid in an expander to produce energy; and a step 704 of cooling the vaporized cyclopentane based fluid to return back to the liquid cyclopentane based fluid and returning the liquid cyclopentane based fluid to the solar power source.

According to another exemplary embodiment illustrated in FIG. 8, there is a method for power (electrical or mechanical) generation using an Organic Rankine Cycle (ORC). The method includes a step 800 of heating with a solar power source an oil based fluid in a first closed system; and a step 802 of expanding a vaporized cyclopentane based fluid in a second closed system for producing energy. The oil based fluid of the first closed system is configured to exchange heat with the liquid cyclopentane based fluid in the second closed system.

According to still another exemplary embodiment, it is possible to provide a new arrangement that is not limited to cyclopentane but may use any ORC fluid (e.g., any organic based fluid). In this embodiment, two distinct solar power sources are used to heat the ORC fluid. The first solar power source is configured to heat an incoming ORC liquid to become saturated and the second solar power source is configured to further heat the saturated ORC liquid to become ORC vapor. A liquid is said to be saturated when it is about to boil. A storage tank for the saturated ORC liquid may be provided between the first and second solar power sources. During periods when the solar power sources are inactive, e.g., cloudily, a secondary power source may be used to transform the saturated ORC liquid into vapor to be provided to the turbo-machine. Alternatively, a throttling wall (or throttling device) may be used to partially transform the saturated ORC liquid (by partially reducing pressure isenthalpically) to vapor as will be discussed later.

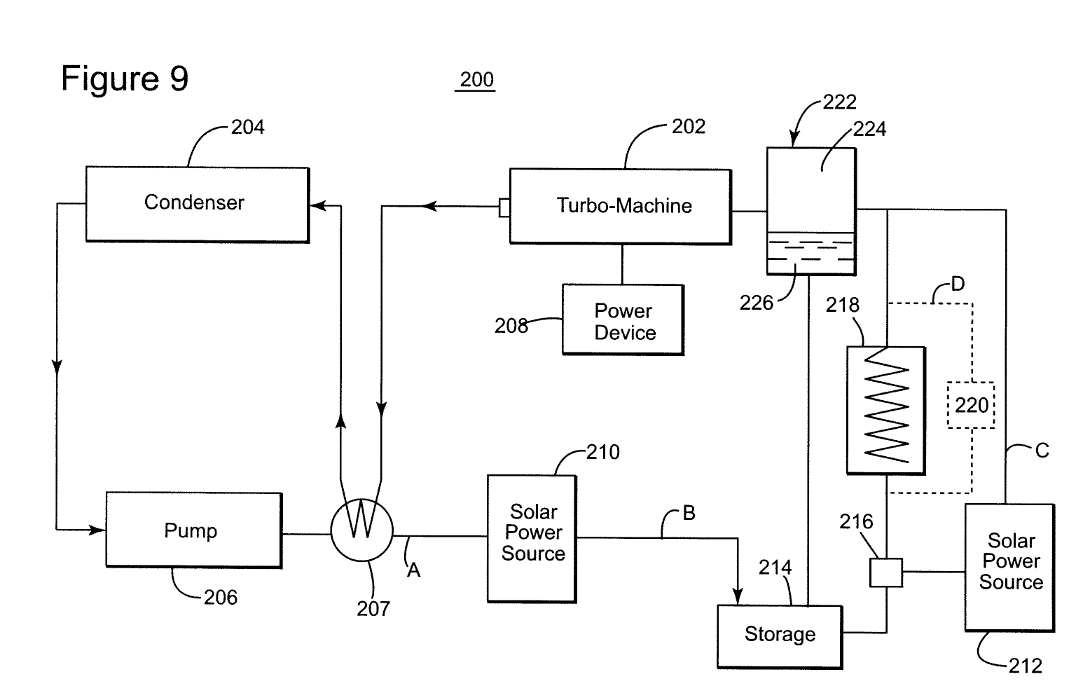

According to an exemplary embodiment illustrated in FIG. 9, a system 200 for power (electrical or mechanical) generation includes a turbo-machine 202, condenser 204, pump 206, recuperator 207, and a power device 208 that are connected to each other in a similar manner as shown in FIGS. 3 and 4. The power device 208 may be an electrical generator (or similar devices for producing electrical energy) or a turbo-machine that is driven by the turbo-machine. However, FIG. 9 shows a first solar power source 210 and a second solar power source 212 interconnected via a liquid storage tank 214. A control device (e.g., valve) 216 or other similar element distributes a flow from the tank 214 either to the second solar power source 212 or to a secondary heat source 218. The secondary heat source 218 may be any heat source.

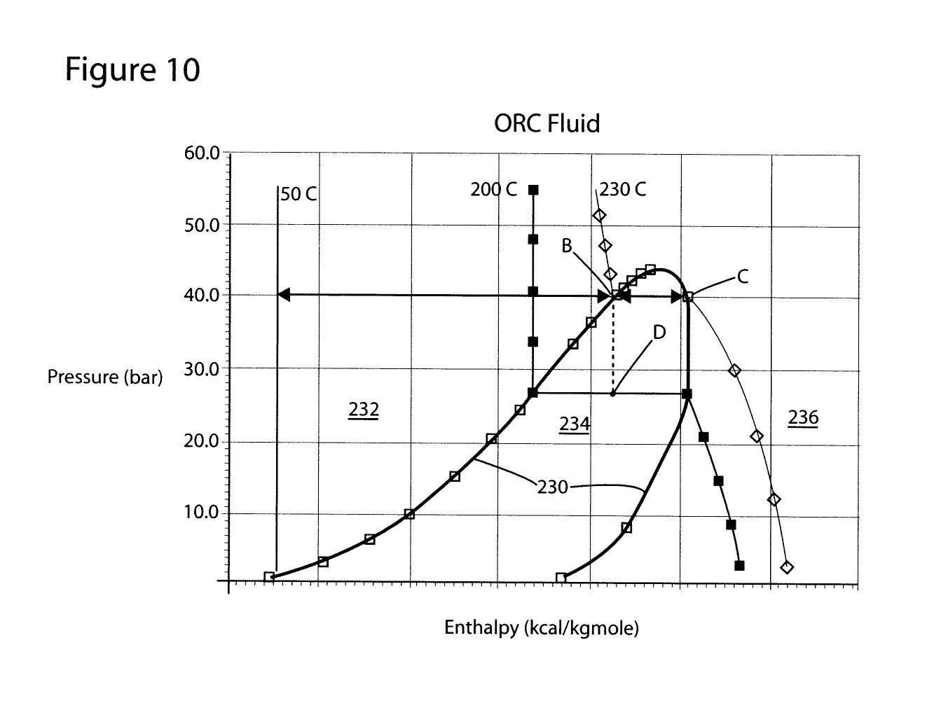

The flow of the ORC fluid is now discussed with regard to FIG. 9 and also with regard to FIG. 10, which shows a pressure-enthalpy (P-H) chart for the ORC fluid. The flow of the ORC fluid through the turbo-machine, condenser, pump and secondary heat source is omitted as has been already discussed. Low temperature ORC liquid enters at point A (see both FIGS. 9 and 10) the first solar power source 210. Heat is transferred from the first solar power source 210 to the ORC fluid so that at point B the ORC liquid is saturated but still liquid. This is illustrated in FIG. 10 in which curve 230 shows the liquid-vapor curve for the ORC fluid. It is noted that the ORC fluid is liquid in region 232, a mixture of liquid and vapor in region 234 and vapor in region 236. Thus, the first power source 210 is designed (e.g., sized) in such a way that the ORC liquid at point B is not inside region 234, i.e., it is saturated but not vaporized.

From here the saturated ORC liquid is directed to and stored in tank 214. If the second solar power source 212 is active, the control device 216 is configured to allow the saturated ORC liquid from the tank 214 to proceed to the second solar power source 212 and not to the secondary heat source 218. The second solar power source 212 is configured to vaporize the saturated ORC liquid so that at point C the entire flow is in the form of vapors. Thus, heat is added during the transition A to B and also during the transition B to C. In a particular example, not intended to limit the invention, when the temperatures are, at A around 50° C., at B around 230° C., and at C around 250° C., the added heat between A and B is around 400 kJ/kg and a latent heat added between B and C is around 40 kJ/kg. It can be seen that the latent heat is low. The ORC vapor is then provided to the turbo-machine 202 for producing mechanical energy.

When the second solar power source 212 is not available, the control device 216 is configured to provide the saturated ORC liquid to the secondary heat source 218 so that the liquid is transformed to vapor and provided to the turbo-machine 202. It is noted that instead of the secondary heat source 218 a throttle wall (or a throttling device) 220 may be used to reduce a pressure isenthalpically of the saturated ORC liquid for transforming it into vapor as shown in FIG. 10 by curve B to D. In this way, part of the saturated ORC liquid remains liquid and part of it is transformed into vapor. It is noted that the B to D transformation results not only in a pressure drop but also in a temperature drop. However, part of the saturated ORC liquid is vaporized without using a heating source. Both the ORC liquid and vapor are provided to a separation device 222 in which the top part is occupied by the vapor 224 and the bottom part is occupied by the liquid 226. The separation device 222 is not used for the heating source 218. The ORC vapor 224 is provided to the turbo-machine 202 while the ORC fluid 226 may be returned to the tank 214 or to the first solar power source 210 or to another part of the closed loop system 200.

In this way, the embodiments illustrated in FIGS. 9 and 10 may continuously provide the necessary ORC vapor to the turbo-machine even when the solar energy is not available.

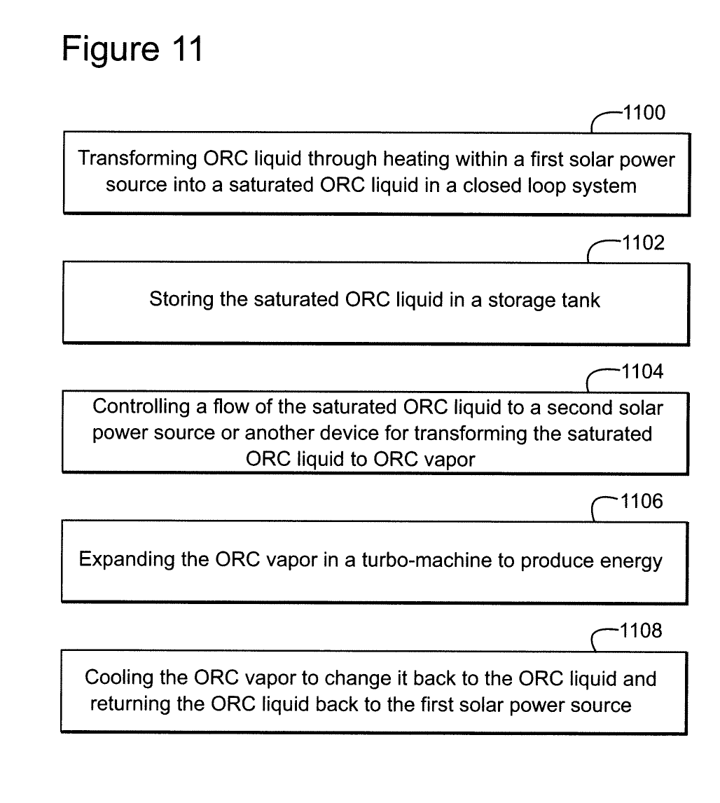

According to an exemplary embodiment illustrated in FIG. 11, there is a method for generating electrical or mechanical power using an Organic Rankine Cycle (ORC). The method includes a step 1100 of transforming ORC liquid through heating within a first solar power source into a saturated ORC liquid in a closed loop system; a step 1102 of storing the saturated ORC liquid in a storage tank; a step 1104 of controlling a flow of the saturated ORC liquid to a second solar power source or another device for transforming the saturated ORC liquid to ORC vapor; a step 1106 of expanding the ORC vapor in a turbo-machine to produce energy; and a step 1108 of cooling the ORC vapor to change it back to the ORC liquid and returning the ORC liquid back to the first solar power source.

The disclosed exemplary embodiments provide a system and a method for transforming solar energy into mechanical energy or electrical energy even when the solar polar is temporarily not available. It should be understood that this description is not intended to limit the present invention. On the contrary, the exemplary embodiments are intended to cover alternatives, modifications and equivalents, which are included in the spirit and scope of the present invention as defined by the appended claims. Further, in the detailed description of the exemplary embodiments, numerous specific details are set forth in order to provide a comprehensive understanding of the present invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A closed loop system for producing energy using an Organic Rankine Cycle (ORC) and an ORC fluid, the system comprising:
a first solar power source configured to heat an ORC liquid to a saturated ORC liquid;
a second solar power source fluidly connected to the first solar power source and configured to vaporize the saturated ORC liquid to become ORC vapor; and
a turbo-machine configured to receive ORC vapor and produce mechanical energy by expanding the ORC vapor.

2. The closed loop system of claim 1, further comprising:
a tank fluidly connected between the first solar power source and the second solar power source and configured to store the saturated ORC liquid.

3. The closed loop system of claim 1, further comprising:
a control device fluidly connected between the tank and the second solar power source and configured to control a flow of the saturated ORC liquid to the second solar power source.

4. The closed loop system of claim 1, further comprising:
a heating device fluidly connected to the control device and configured to vaporize the saturated ORC liquid, wherein the control device is configured to direct the saturated ORC liquid from the tank to the heating device and not to the second solar power source when the second solar power source is not active.

5. The closed loop system of claim 1, further comprising:
a throttling device fluidly connected to the control device and configured to vaporize the saturated ORC liquid by reducing its pressure, wherein the control device is configured to direct the saturated ORC liquid from the tank to the throttling device and not to the second solar power source when the second solar power source is not active.

6. The closed loop system of claim 1, further comprising:
a separation tank fluidly connected between the throttling device and the turbo-machine and configured to provide the ORC vapor to the turbo-machine and the saturated ORC liquid back to the tank or the first solar power source.

7. The closed loop system of claim 1, wherein the first solar power source is configured to not vaporize the ORC liquid.

8. The closed loop system of claim 1, further comprising:
a recuperator fluidly connected to an output of the turbo-machine and configured to remove heat from the vaporized ORC fluid;
a cooling device fluidly connected to the recuperator and configured to transform the vaporized ORC fluid back to the ORC liquid; and
a pump fluidly connected between the cooling device and the recuperator and configured to pump the ORC liquid to the recuperator,
wherein the pumped ORC liquid from the pump receives heat in the recuperator from the vaporized ORC fluid coming from an expander of the turbo-machine.

9. A closed loop system for producing energy using an Organic Rankine Cycle (ORC) and an ORC fluid, the system comprising:
a turbo-machine configured to transform heat into mechanical energy;
a recuperator fluidly connected to an output of the turbo-machine and configured to remove heat from the vaporized ORC fluid;
a cooling device fluidly connected to the recuperator and configured to transform the vaporized ORC fluid back to the ORC liquid;
a pump fluidly connected between the cooling device and the recuperator and configured to pump the ORC liquid to the recuperator;
a first solar power source configured to transform by heating the ORC liquid to a saturated ORC liquid; and
a second solar power source fluidly connected to the first solar power source and configured to vaporize the saturated ORC liquid to become ORC vapor,
wherein the turbo-machine is configured to receive the ORC vapor from the second solar power source.

10. The closed loop system of claim 9, further comprising:
a tank fluidly connected between the first solar power source and the second solar power source and configured to store the saturated ORC vapor.

11. The closed loop system of claim 9, further comprising:
a control device fluidly connected between the tank and the second solar power source and configured to control a flow of the saturated ORC liquid to the second solar power source.

12. The closed loop system of claim 9, further comprising:
a heating device fluidly connected between the control device and the turbo-machine and configured to vaporize the saturated ORC liquid, wherein the control device is configured to direct the saturated ORC liquid from the tank to the heating device and not to the second solar power source when the second solar power source is not active.

13. The closed loop system of claim 9, further comprising:
a throttling device fluidly connected to the control device and configured to vaporize the saturated ORC liquid by reducing its pressure, wherein the control device is configured to direct the saturated ORC liquid from the tank to the throttling device and not to the second solar power source when the second solar power source is not active.

14. The closed loop system of claim 9, further comprising:
a separation tank fluidly connected between the throttling device and the turbo-machine and configured to provide the ORC vapor to the turbo-machine and the saturated ORC liquid back to the tank or the first solar power source.

15. The closed loop system of claim 9, wherein the first solar power source is configured to not vaporize the ORC liquid.

16. A method for generating energy using an Organic Rankine Cycle (ORC), the method comprising:
transforming ORC liquid through heating within a first solar power source into a saturated ORC liquid in a closed loop system;
storing the saturated ORC liquid in a storage tank;
controlling a flow of the saturated ORC liquid to a second solar power source or another device for transforming the saturated ORC liquid to ORC vapor;
expanding the ORC vapor in a turbo-machine to produce the energy; and
cooling the ORC vapor to change it back to the ORC liquid and returning the ORC liquid back to the first solar power source.

17. The method of claim 16, further comprising:
vaporizing the saturated ORC fluid in the second solar power source but not vaporizing the ORC fluid in the first solar power source.

18. The method of claim 16, further comprising:
heating with a heat source the saturated ORC liquid coming from a control device to become the ORC vapor prior to providing it to an expander of the turbo-machine.

19. The method of claim 16, further comprising:
decreasing, in a throttling device, a pressure of the saturated ORC liquid coming from a control device to become partially ORC vapor prior to providing the ORC vapor to an expander of the turbo-machine.

20. The method of claim 16, further comprising:
separating saturated ORC liquid from ORC vapor in a separation tank fluidly connected between the turbo-machine and the throttling device.
